(19) United States
(12) Patent Application Publication
(10) Pub. No.: US 2007/0274845 A1
(43) Pub. Date: Nov. 29, 2007

(54) Fluid Storage And Dispensing System

(75) Inventors: David Russell Ruprecht, New Tripoli, PA (US); Shawn Richard McCall, Alburtis, PA (US); Steven James DeMaio, Allentown, PA (US); Ashok Narain Mathur, Allentown, PA (US)

Correspondence Address: AIR PRODUCTS AND CHEMICALS, INC.;PATENT DEPARTMENT, 7201 HAMILTON BOULEVARD, ALLENTOWN, PA, 181951501, US

(73) Assignee: Air Products and Chemicals, Inc., Allentown, PA (US)

(21) Appl. No.: 11/748,778

(22) Filed: May 15, 2007

Related U.S. Application Data
(60) Provisional application No. 60/808,508, filed on May 25, 2006.

(51) Int. Cl. F04B 17/00; F04B 35/02; B01D 53/22; B01D 46/46

(52) U.S. Cl. 417/390; 417/384; 95/15; 96/4

(57) ABSTRACT

Fluid storage and dispensing system comprising a pressure vessel having a moveable partition member dividing the interior into first and second variable volumes. The first variable volume has a first passage adapted for the inflow and outflow of a product fluid and the second variable volume has a second passage adapted for the inflow and outflow of a compensating gas. The system includes (1) a compensating gas line for providing compensating gas, (2) a first orifice that is installed in the compensating gas line and has an upstream side and a downstream side, (3) a compensating gas vent line connected to the compensating gas line between the second passage and the downstream side of the first orifice, and (4) a second orifice installed in the compensating gas vent line, wherein the cross-sectional flow area of the second orifice is smaller than the cross-sectional flow area of the first orifice.

### CROSS-REFERENCE TO RELATED APPLICATIONS

This application claims priority to Provisional Application No. 60/808,508 filed on May 25, 2006.

### BACKGROUND OF THE INVENTION

The generation and dispensing of a fluid or gaseous product by integrated production systems is widely used in commercial and industrial applications in which the flow demand for the fluid product is variable or intermittent. In order to meet variable flow demand, the integrated production system typically includes a product fluid storage tank or surge tank to meet peak product flow demands that exceed the capacity of the fluid or gas generation equipment. An example of such an application is the separation of nitrogen from air by a pressure swing adsorption or membrane system wherein the nitrogen is used for purging, inerting, tire inflation, and related applications. The generated nitrogen gas typically is stored in a surge tank at an appropriate pressure to supply peak flow demands that exceed the capacity of the adsorption or membrane system.

In many of these applications, the peak flow demand requires a large surge tank, which can occupy significant floor space and limit the portability of the generating and dispensing system. Because it is often necessary to minimize the system floor space requirement and to move the system about an operating site, there is a need for improved fluid generation and dispensing systems with smaller storage tanks that allow easy system portability. This need is addressed by the embodiments of the present invention as described below and defined by the claims that follow.

### BRIEF SUMMARY OF THE INVENTION

An embodiment of the invention relates to a fluid storage and dispensing system comprising
(a) a pressure vessel having an inner surface, an interior, an exterior, and a rigid wall between the interior and exterior;
(b) a moveable partition member disposed in the interior of the pressure vessel, wherein the partition member divides the interior into a first variable volume and a second variable volume, and wherein the first variable volume is not in flow communication with the second variable volume;
(c) a first passage passing through the rigid wall of the pressure vessel and into the first variable volume wherein the first passage is adapted to introduce a product fluid into the first variable volume and withdraw the product fluid from the first variable volume; and
(d) a second passage passing through the rigid wall of the pressure vessel and into the second variable volume wherein the second passage is adapted to introduce a compensating gas into the second variable volume and withdraw the compensating gas from the second variable volume.
   This system also comprises a compensating gas supply system that includes
(1) a compensating gas line placing the second passage in flow communication with a source of compensating gas;
(2) a first orifice installed in the compensating gas line and having an upstream side and a downstream side;
(3) a compensating gas vent line in flow communication with the compensating gas line at a location between the second passage and the downstream side of the first orifice, wherein the compensating gas vent line is adapted to discharge compensating gas from the compensating gas line to the atmosphere; and
(4) a second orifice installed in the compensating gas vent line, wherein the cross-sectional flow area of the second orifice is smaller than the cross-sectional flow area of the first orifice.
   Another embodiment includes a fluid storage and dispensing system comprising
(a) a pressure vessel having an inner surface, an interior, an exterior, and a rigid wall between the interior and exterior;
(b) a flexible fluid container disposed in the interior of the pressure vessel, wherein the flexible fluid container has an interior, an outer surface, and an opening connecting the interior of the container with a first passage through the rigid wall of the pressure vessel;
(c) a first variable volume defined by the interior of the flexible fluid container, wherein the first passage is in flow communication with a product fluid supply line and a product fluid dispensing line and is adapted to introduce a product fluid into the first variable volume and withdraw the product fluid from the first variable volume;
(d) a second variable volume defined by the inner surface of the pressure vessel and the outer surface of the flexible fluid container, wherein the second variable volume is in flow communication with a second passage adapted to introduce a compensating gas into the second variable volume and to withdraw the compensating gas from the second variable volume; and
(e) a compensating gas supply system that includes
   (1) a compensating gas line placing the second passage in flow communication with a source of compensating gas;
   (2) a first orifice installed in the compensating gas line and having an upstream side and a downstream side;
   (3) a compensating gas vent line in flow communication with the compensating gas line at a location between the second passage and the downstream side of the first orifice, wherein the compensating gas vent line is adapted to discharge compensating gas from the compensating gas line to the atmosphere; and
   (4) a second orifice installed in the compensating gas vent line, wherein the cross-sectional flow area of the second orifice is smaller than the cross-sectional flow area of the first orifice.

A related embodiment includes a method of storing and dispensing a fluid comprising
(a) providing a fluid storage and dispensing system that comprises
   (1) a pressure vessel having an inner surface, an interior, an exterior, and a rigid wall between the interior and exterior;
   (2) a flexible fluid container disposed in the interior of the pressure vessel, wherein the flexible fluid container has an interior, an outer surface, and an opening connecting the interior of the container with a first passage through the rigid wall of the pressure vessel;
   (3) a first variable volume defined by the interior of the flexible fluid container, wherein the first passage is in flow communication with a product fluid supply line and a product fluid dispensing line and is adapted to introduce a product fluid into the first variable volume and withdraw the product fluid from the first variable volume;
   (4) a second variable volume defined by the inner surface of the pressure vessel and the outer surface of the flexible fluid container, wherein the second variable volume is in flow communication with a second passage adapted to introduce a compensating gas into the second variable volume and to withdraw the compensating gas from the second variable volume; and
   (5) a compensating gas supply system that includes
      (i) a compensating gas line placing the second passage in flow communication with a source of compensating gas;
      (ii) a first orifice installed in the compensating gas line and having an upstream side and a downstream side;
      (iii) a compensating gas vent line in flow communication with the compensating gas line at a location between the second passage and the downstream side of the first orifice, wherein the compensating gas vent line is adapted to discharge compensating gas from the compensating gas line to the atmosphere; and
      (iv) a second orifice installed in the compensating gas vent line, wherein the cross-sectional flow area of the second orifice is smaller than the cross-sectional flow area of the first orifice;
(b) during a first time period, withdrawing product fluid from the first variable volume, combining it with product fluid from the product fluid supply line to provide a combined product fluid, introducing the combined product fluid into the product fluid dispensing line, and introducing compensating gas into the second variable volume via the first orifice and the compensating gas line; and
(c) during a second time period, introducing a first portion of product fluid from the product fluid supply line into the product fluid dispensing line, introducing a second portion of product fluid from the product fluid supply line into the first variable volume, and withdrawing compensating gas from the second variable volume via the second orifice and the compensating gas vent line.

Another related embodiment relates to a gas generation, storage, and dispensing system comprising
(a) a pressure vessel having an inner surface, an interior, an exterior, and a rigid wall between the interior and exterior;
(b) a flexible gas container disposed in the interior of the pressure vessel, wherein the flexible gas container has an interior, an outer surface, and an opening connecting the interior of the container with a first passage through the rigid wall of the pressure vessel;
(c) a first variable volume defined by the interior of the flexible gas container, wherein the first passage is in direct flow communication with a product gas supply line and a product gas dispensing line and is adapted to introduce a product gas into the first variable volume and withdraw the product gas from the first variable volume;
(d) a second variable volume defined by the inner surface of the pressure vessel and the outer surface of the flexible fluid container, wherein the second variable volume is in flow communication with a second passage adapted to introduce a compensating gas into the second variable volume and to withdraw the compensating gas from the second variable; and
(e) a pressure swing adsorption system comprising at least one vessel containing adsorbent material adapted to preferentially adsorb a more strongly adsorbable component from a gas mixture comprising the more strongly adsorbable component and a less strongly adsorbable component to provide an effluent gas enriched in the less strongly adsorbable component, wherein the pressure swing adsorption system includes outlet piping adapted to provide the effluent gas directly to the first variable volume via the product gas supply line and the first passage.

Another embodiment includes a method for generating, storing, and dispensing a gas comprising
(a) providing a gas storage and dispensing system that comprises
   (1) a pressure vessel having an inner surface, an interior, an exterior, and a rigid wall between the interior and exterior;
   (2) a flexible gas container disposed in the interior of the pressure vessel, wherein the flexible gas container has an interior, an outer surface, and an opening connecting the interior of the container with a first passage through the rigid wall of the pressure vessel;
   (3) a first variable volume defined by the interior of the flexible gas container, wherein the first passage is in direct flow communication with a product gas supply line and a product gas dispensing line and is adapted to introduce a product gas into the first variable volume and withdraw the product gas from the first variable volume;
   (4) a second variable volume defined by the inner surface of the pressure vessel and the outer surface of the flexible gas container, wherein the second variable volume is in flow communication with a second passage adapted to introduce a compensating gas into the second variable volume via a compensating gas line and to withdraw the compensating gas from the second variable volume via the compensating gas line; and
(b) introducing a feed gas mixture comprising a more strongly adsorbable component and a less strongly adsorbable component into an adsorber vessel containing adsorbent material, preferentially adsorbing a portion of the more strongly adsorbable component on the adsorbent material, withdrawing from the adsorber vessel an effluent gas enriched in the less strongly adsorbable component to provide the product gas, and introducing the product gas directly into the product gas supply line.

### BRIEF DESCRIPTION OF SEVERAL VIEWS OF THE DRAWINGS

FIG. 1 is a schematic flow diagram of a generic embodiment of the present invention.

FIG. 2 is a sectional view of a bladder-type storage tank used in an embodiment of the invention.

FIG. 3 is a schematic piping and instrumentation diagram for a specific embodiment of the invention utilizing pressure swing adsorption integrated with a bladder-type storage tank.

These drawings illustrate embodiments of the invention without implying the exact relationships and sizes of the components shown, are not necessarily to scale, and are not meant to limit these embodiments to any of the features shown therein.

### DETAILED DESCRIPTION OF THE EMBODIMENTS OF THE INVENTION

The embodiments of the present invention provide systems and methods for supplying a pressurized fluid in applications wherein the flow demand for the pressurized fluid is variable and/or intermittent. The embodiments utilize a fluid or gas storage system comprising a pressure vessel having an inner surface, an interior, an exterior, and a rigid wall between the interior and exterior. A moveable partition member is disposed in the interior of the pressure vessel, and the partition member divides the interior into a first variable volume and a second variable volume. The first variable volume is not in flow communication with the second variable volume and the partition member isolates the first variable volume from the second variable volume. The total volume of the first variable volume and the second variable volume typically may be essentially constant. A first passage through the rigid wall of the pressure vessel leads into the first variable volume, and the first passage is adapted to introduce a product fluid into the first variable volume and withdraw the product fluid from the first variable volume. A second passage through the rigid wall of the pressure vessel leads into the second variable volume, and the second passage is adapted to introduce a compensating gas into the second variable volume and withdraw the compensating gas from the second variable volume. The compensating gas allows product fluid to be introduced into or withdrawn from the interior of the flexible fluid container at an essentially constant pressure equal to the required supply pressure of the product fluid.

The system uses a compensating gas supply system that includes (1) a compensating gas line placing the second passage in flow communication with a source of compensating gas; (2) a first orifice installed in the compensating gas line and having an upstream side and a downstream side; (3) a compensating gas vent line in flow communication with the compensating gas line at a location between the second passage and the downstream side of the first orifice, wherein the compensating gas vent line is adapted to discharge compensating gas from the compensating gas line to the atmosphere; and (4) a second orifice installed in the compensating gas vent line, wherein the cross-sectional flow area of the second orifice is smaller than the cross-sectional flow area of the first orifice.

A compensating gas is defined as a gas introduced into or withdrawn from the second variable volume as the first variable volume contracts or expands, respectively. The compensating gas maintains a pressure in the second variable volume that is essentially equal to the pressure in the first variable volume.

The first and second variable volumes within the interior of the pressure vessel may be defined by several types of moveable partition members. In one embodiment, a bladder bag may be used wherein the bag wall is the moveable partition member, the first variable volume is defined by the interior of the bladder bag, and the second variable volume is defined by the inner surface of the pressure vessel and the outer surface of the bladder bag. In another embodiment, a bellows assembly may be used wherein the bellows wall is the moveable partition member, the first variable volume is defined by the interior of the bellows, and the second variable volume is defined by the inner surface of the pressure vessel and the outer surface of the bellows.

In an alternative embodiment, a flexible diaphragm assembly may be used wherein the outer periphery of the diaphragm is sealed to the inner wall of the pressure vessel and the diaphragm is the moveable partition member. The diaphragm is formed of a bendable and/or stretchable material. The first variable volume is defined by one side of the diaphragm and the inner surface of the pressure vessel on that side of the diaphragm, and the second variable volume is defined by the other side of the diaphragm and the inner surface of the pressure vessel on that side of the diaphragm.

In another alternative embodiment, a piston may be used as the moveable partition member to form a slideable seal against the inner surface of the pressure vessel. The first variable volume is defined by one side of the piston and the inner surface of the pressure vessel on that side of the piston, and the second variable volume is defined by the other side of the piston and the inner surface of the pressure vessel on that side of the piston.

Any other type of moveable partition members and pressure vessels may be used as desired to provide the functions of the first and second variable volumes as defined above.

Certain embodiments of the present invention utilize a fluid or gas storage system comprising a flexible fluid container disposed in the interior of a pressure vessel with a compensating gas that controls the pressure in the volume between the outer surface of the flexible fluid container and the inner surface of the pressure vessel. The flexible fluid container may be, for example, a bladder bag or a bellows assembly as described above. The compensating gas allows product fluid or gas to be introduced into or withdrawn from the interior of the flexible fluid container at an essentially constant pressure equal to the required supply pressure of the product fluid or gas. The flexible fluid container may be integrated with a separation unit that generates the product gas, wherein the integrated fluid container and separation unit provides the required peak product flow rates while minimizing the size of the integrated system.

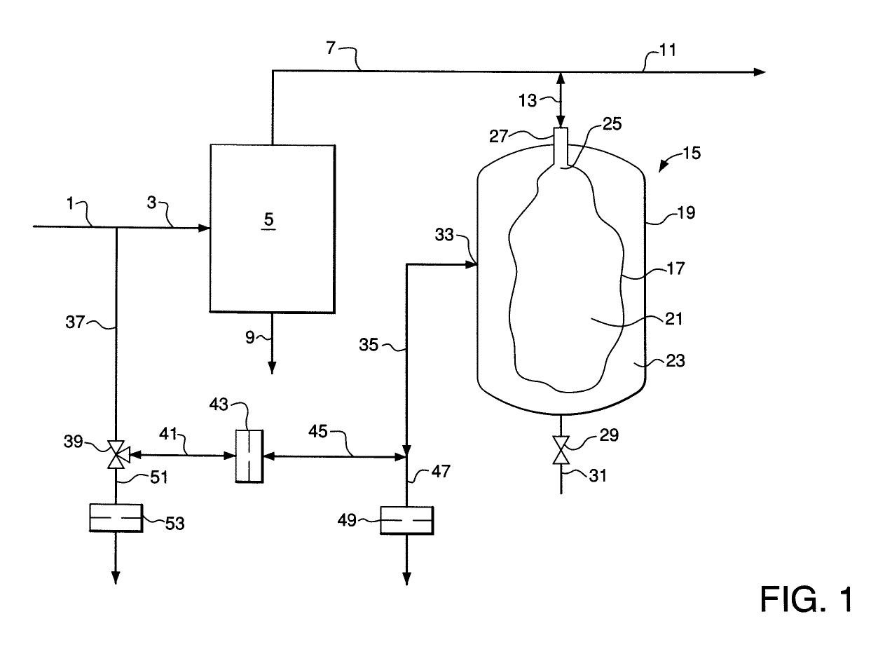

An exemplary embodiment of the invention is illustrated in FIG. 1 for the recovery of nitrogen from air and the dispensing of the recovered nitrogen to a consumer at a desired pressure and range of product flow rates. In this illustration, atmospheric air is provided at a pressure between about 110 and about 160 psig via line 1 and a first portion thereof flows via line 3 to air separation system 5. Air separation can be effected by any known method such as, for example, pressure swing adsorption or membrane separation. The separation system provides a pressurized nitrogen product gas via product fluid supply line 7 at or above a designated purity at flow rates up to the design flow rate of the system. The product gas typically contains at least 95 vol % nitrogen at or below the design product flow rate, a pressure slightly below the feed gas pressure in line 1, and an ambient temperature between about 50 and 90° F. Waste gas depleted in nitrogen is discharged via vent line 9. If the air separation system is operated above the design product flow rate, the product purity will be less than 95 vol % nitrogen.

Nitrogen product gas is delivered to an end user via product fluid dispensing line 11 at time-variant flow rates, some of which may exceed the production capacity of air separation system 5. Alternatively or additionally, the demand for nitrogen by the end user may be intermittent. The feed air in line 1 is provided at a pressure sufficient to satisfy the pressure requirements of the gas in product fluid dispensing line 11. In order to meet the variable and/or intermittent product gas demand, a portion of the generated nitrogen may be directed via line 13 to variable-volume gas storage system 15 comprising flexible fluid or gas container 17 disposed in the interior of rigid-walled pressure vessel 19. The system forms a first variable volume defined by interior 21 of flexible container 17 and a second variable volume 23 formed between the outer surface of flexible container 17 and the inner surface of pressure vessel 19.

Flexible container 17 has opening 25 that connects container interior 21 to passage 27 that is in flow communication via line 13 with product fluid supply line 7 and product fluid dispensing line 11. Flexible container 17 may be formed by any type of variable-volume device having flexible, expandable, and/or stretchable walls such as a bladder bag made of polymeric material or a bellows made of metallic or polymeric material. In this embodiment, flexible container 17 is a bladder bag made of a polymeric material such as, for example, butyl rubber. The polymeric material should be compatible with the fluid contained in the bladder bag. Passage 27 passes through and is sealably retained in an opening through the upper wall or head of pressure vessel 19. Second variable volume 23 may be vented if necessary via valve 29 and vent line 31.

Pressure vessel 19 has opening 33 for the introduction and withdrawal of compensating gas via compensating gas line 35. In this embodiment, the compensating gas is air, but any appropriate gas may be used that is compatible with the material of flexible container 17. The compensating gas is provided as a second portion of the feed air from line 1 and flows via line 37, three-way two-position valve 39, and line 41 to orifice 43. Line 45 places orifice 43 in flow communication with compensating gas line 35 and compensating gas vent line 47. Orifice 49 is installed in vent line 47 to control a flow of compensating gas to the atmosphere via orifice 49. Vent line 51 is connected to three-way two-position valve 39 and orifice 53 is installed in vent line 53 51 to allow additional venting of compensating gas as explained below. In an alternative embodiment, three-way valve 39 and flow orifice 53 are not included and all vented compensating gas flows via orifice 49.

The compensating gas circuit is designed to provide compensating air to second variable volume 23 when product gas is flowing out of flexible container 17 and to withdraw compensating air from second variable volume 23 when product gas is flowing into flexible container 17. Each orifice typically comprises a circular opening drilled in an orifice plate as is known in the fluid flow art. The cross-sectional flow areas and diameters of orifices 43 and 49 are selected to provide compensating air at the required pressure and flow rate to second variable volume 23 when product gas is withdrawn from flexible container 17. Orifice 43 is sized to provide compensating gas at approximately the same molar flow rate as that of the product gas withdrawn from flexible container 17. Orifice 49 is sized to create a backpressure in lines 35 and 45 when no product gas is being discharged from flexible container 17 that is approximately equal to the required product gas supply pressure. When three-way valve 39 and flow orifice 53 are included, compensating gas vents via orifice 53 in addition to orifice 49 when the flexible container 17 is full of nitrogen product gas. Three-way valve 39 shuts off compensating gas flow via line 37, thus conserving compensating gas when no product gas is being discharged from flexible container 17.

The term “in flow communication with” as applied to a first and second region means that fluid can flow from the first region to the second region, and/or from the second region to the first region, through connecting piping and/or an intermediate region. The term “connected to” as applied to a first and second region means that fluid can flow from the first region directly to the second region or through connecting piping to the second region. The term “direct flow communication” and the terms “direct” or “directly” as applied to a flowing fluid mean that the fluid can flow from a first region to a second region, and/or from the second region to the first region, wherein the flow path between the regions is not in flow communication with any vessel, storage tank, or process equipment, except that the fluid flow path may include piping and/or one or more flow control devices selected from orifices and valves. The term “enriched” refers to a fluid or gas product or byproduct stream withdrawn from a separation process wherein the concentration of a component in the product or byproduct stream is greater than the concentration of that component in the feed to the separation process.

The generic term “pressure swing adsorption” (PSA) as used herein applies to all adsorptive separation systems operating between a maximum and a minimum pressure. The maximum pressure typically is super-atmospheric, and the minimum pressure may be super-atmospheric, atmospheric, or sub-atmospheric.

The indefinite articles “a” and “an” as used herein mean one or more when applied to any feature in embodiments of the present invention described in the specification and claims. The use of “a” and “an” does not limit the meaning to a single feature unless such a limit is specifically stated. The definite article “the” preceding singular or plural nouns or noun phrases denotes a particular specified feature or particular specified features and may have a singular or plural connotation depending upon the context in which it is used. The adjective “any” means one, some, or all indiscriminately of whatever quantity. The term “and/or” placed between a first entity and a second entity means one of (1) the first entity, (2) the second entity, and (3) the first entity and the second entity.

A fluid as used herein may be a liquid, a gas, or a supercritical fluid and may comprise one or more components.

Referring again to FIG. 1, the compensating gas circuit provides a minimum backpressure on air separation system 5 via variable-volume gas storage system 15 and thus sets the maximum pressure drop through the air separation system. For example, the compensating gas circuit may be designed to maintain a pressure of about 130 psig in interior 21 of flexible container 17, which in turn maintains the pressure in product fluid supply line 7 at about 130 psig. The feed air may be provided via line 1 at a typical pressure of about 140 psig, thereby limiting the pressure drop through air separation system 5, which in turn limits the flow rate through the system. This acts to maintain a minimum nitrogen product purity, for example, 95 vol % nitrogen. Air separation system 5 may be any of the pressure swing adsorption (PSA) or membrane permeation systems known in the art. In the operation of currently-available PSA and membrane nitrogen generators, high flow demand from the end user may result in a decrease in the discharge pressure from the nitrogen generator, thereby increasing the pressure drop through the nitrogen generator, which in turn reduces the retention time in the nitrogen separator and results in lower nitrogen product purity.

The system of FIG. 1 is adapted to operate in any of five modes described below depending on the timing, duration, and flow rate of product gas demanded by the end user via line 11.
1) In a first or standby mode, there is no demand by the user, flexible container 17 is full and occupies the entire interior of pressure vessel 19, and the compensating gas volume in second variable volume 23 of variable-volume gas storage system 15 is essentially zero. Air separation system 5 is on standby. In this mode, there is no compensating gas flow into second variable volume 23, and compensating gas provided via orifice 43 vents via orifice 49 while maintaining the appropriate backpressure in line 35. If optional three-way two-position valve 39 and orifice 53 are used, the valve is closed against line 37 and open between lines 41 and 51, thereby placing the compensating gas circuit open to the atmosphere via orifice 53. There is no gas flow in any of the lines in this option.
2) In a second operating mode, the demand for product gas via product fluid dispensing line 11 exceeds the available flow of product gas in product fluid supply line 7, and flexible container 17 contains stored product gas. This may occur (a) when gas is first demanded by the user after the system has been in standby mode and the air separation system requires a short time period to reach steady state operation and/or (b) when user demand is greater that the air separation system capacity at design purity. During these situations in this operating mode, product shortfall is provided by gas outflow from flexible container 17 via line 13. As product gas flows out of flexible container 17, compensating gas flows via line 35 into second variable volume 23 at approximately the same molar flow rate and pressure as the product gas.
3) In a third operating mode, the demand for product gas via product fluid dispensing line 11 is less than the flow of product gas in product fluid supply line 7, and flexible container 17 is not filled with product gas. During this situation, product gas flows into flexible container 17 via line 13 while product gas flows to the user via product fluid dispensing line 11. As product gas flows into flexible container 17, compensating gas from second variable volume 23 flows via line 35 at approximately the same molar flow rate and pressure as the product gas flows into flexible container 17. Excess compensating gas vents via line 47 and orifice 49. If optional three-way valve 39 and orifice 53 are used, additional compensating gas vents via line 51 and orifice 53, and compensating gas flow in line 37 is shut off.
4) In a fourth operating mode, flexible container 17 is full of product gas and the user product gas demand is equal to or less than the capacity of air separation system 5 at design purity. In this mode, there is no compensating gas flow into second variable volume 23, and compensating gas provided via orifice 43 vents via orifice 49 while maintaining the appropriate backpressure in line 35. If optional three-way valve 39 and orifice 53 are used and the product gas flow in line 11 is less than a predetermined value (for example, 1.2 SCFM), additional compensating gas vents via line 51 and orifice 53, compensating gas flow in line 37 is shut off, and the pressure in line 35 goes to atmospheric pressure. If the product flow in line 11 is equal or greater than a predetermined value (for example, 1.2 SCFM), optional three-way valve 39 will activate and allow compensating gas from 37 to be delivered to 33.
5) In a fifth operating mode, the demand for product gas via product fluid dispensing line 11 exceeds the capacity of air separation system 5 at design purity and flexible container 17 is empty. This mode will occur rarely, but if it does occur, a higher product flow will be provided by air separation system 5 at reduced product purity. In this mode, there is no compensating gas flow into second variable volume 23 because it is full. Compensating gas provided via orifice 43 vents via orifice 49 while maintaining the appropriate backpressure in line 35 and in second variable volume 23.

The compensating gas as used in the above description serves by definition to maintain a pressure in second variable volume 23 that is essentially equal to the pressure in flexible container 17. The meaning of “essentially equal to” means that the pressure differential between the gas in second variable volume 23 and first variable volume 21 is usually negligible or zero, but may vary slightly at the beginning or end of certain operating modes described above.

Compensating gas flowing into second variable volume 23 replaces the volume of product gas withdrawn from flexible container 17. There is no substantial pressure differential between second variable volume 23 and flexible container 17 to force gas out of flexible container 17, and second variable volume 23 does not function as a gas compressor to drive product gas from flexible container 17 to the end user. Conversely, compensating gas flows out of second variable volume 23 as a corresponding volume of product gas flows into flexible container 17. There is no substantial pressure differential between flexible container 17 and second variable volume 23 to draw gas into flexible container 17, and second variable volume 23 does not function to draw gas into flexible container 17. The pressure of product gas in flexible container 17 is maintained by the product gas pressure from air separation system 5 and the product gas pressure to the end user via product fluid dispensing line 11 is provided by the product gas pressure from air separation system 5.

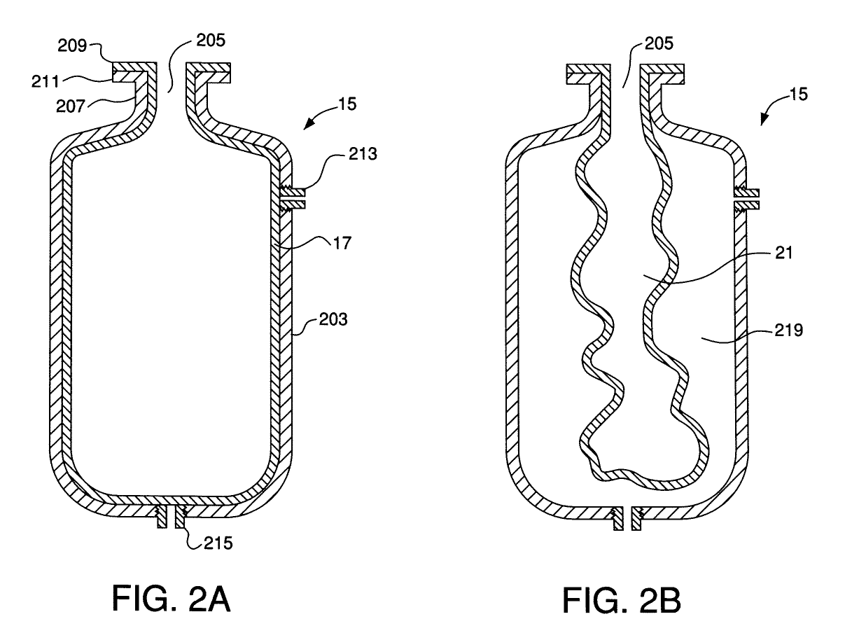

An exemplary embodiment of variable-volume gas storage system 15 is shown in FIGS. 2A and 2B. In this embodiment, variable volume 21 of FIG. 1 is a bladder bag made of a polymeric material such as, for example, butyl rubber. The polymeric material should be compatible with the fluid contained in the bladder bag. In FIG. 2A, bladder bag 17 is installed within pressure vessel 203 such that the walls of the bladder bag are in contact with the inner walls of the vessel when the bladder bag is full at essentially the product gas pressure. Variable-volume gas storage system 15 may be designed advantageously such that the shape of the bladder bag in this mode maps or conforms to the shape of the inner surface of pressure vessel 203 and second variable volume 219 is essentially zero. The polymeric material of the bladder bag in this mode may be in a non-stretched condition wherein the tensile strain in the polymeric material in directions generally parallel to the outer surface of the bladder bag is negligible or essentially zero. Alternatively, the polymeric material of the bladder bag in this mode may be in a stretched condition wherein the tensile strain in the polymeric material in directions generally parallel to the outer surface of the bladder bag is positive.

Inlet/outlet passage 205 of bladder bag 17 passes through similarly-shaped neck 207 of pressure vessel 203 and is sealably retained at the outlet of the opening by flange section 209 in contact with the face of vessel flange 211. A mating flange (not shown) seals flange section 209 against the face of vessel flange 211. Other methods of sealing the outlet of bladder bag 17 to the outlet of pressure vessel 203 can be envisioned which minimizes or eliminates the possibility of undesirable stretching of the walls of the bladder bag. Pressure vessel 203 has essentially rigid walls and may be fabricated of any material that is sufficiently rigid over the operating pressure range. This material typically is carbon steel or another steel alloy, but may be fiber-reinforced polymeric material or other non-metallic materials known in the pressure vessel art. Pressure vessel 203 includes compensating gas inlet/outlet 213 and optional vent connection 215.

FIG. 2B illustrates the configuration of bladder bag 201 when variable-volume gas storage system 15 is in a mode wherein gas has been withdrawn from the interior of bladder bag 17 to provide a flow rate of product gas to the end user that is greater than the nitrogen production capacity of air separation system 5. In this mode, the bag contracts and folds as interior volume 21 decreases and as second variable volume 219 increases as shown. As the bladder bag contracts, the walls flex with minimum bending stress because the bag is not constrained by interior structural components of pressure vessel 203. The decrease in interior volume 21 corresponds to an increase in second variable volume 219 as compensating gas flows into inlet/outlet 213 at essentially the same molar flow rate and essentially the same pressure as the product gas withdrawn via opening 205.

The combination of variable-volume gas storage system 15 and the compensating gas controller of FIG. 1 has at least two operating functions: (1) it provides product gas when end user demand exceeds the production capacity of air separation system 5 and (2) it controls the backpressure on air separation system 5, thereby maintaining product purity. The variable-volume gas storage system has a third function when air separation system 5 is a PSA system operating in a cycle that has a period without product generation. This third function provides a buffer volume so that product can be provided to the end user during the PSA non-production period. This non-production period may occur, for example, in a single-bed PSA system or in a two-bed system that operates with a step of gas transfer between beds.

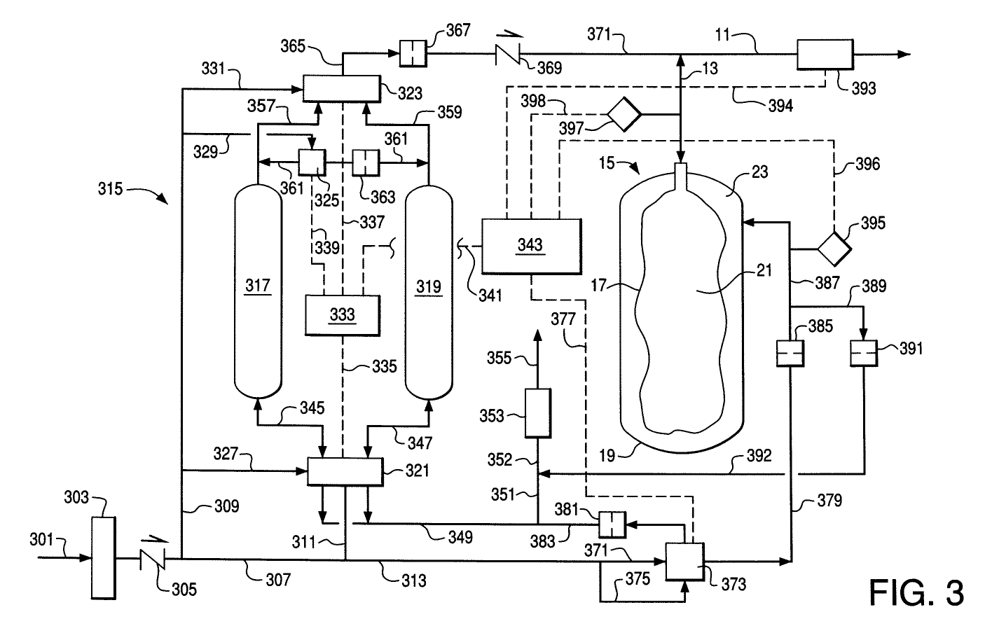

A schematic piping and instrumentation diagram is illustrated in FIG. 3 for a non-limiting embodiment of the invention that utilizes pressure swing adsorption integrated with a bladder-type storage tank to provide nitrogen product to an end user. In this embodiment, pressurized feed air is provided at 110 to 160 psig via line 301, is optionally filtered in filter 303, and flows through check valve 305. The pressurized feed air, which should be filtered and dried, may be provided by the end user or by a separate air compression system (not shown). A first portion of the feed air flows via line 307 and a second portion flows via line 309 to provide pilot air for valve operation as described below. A portion of the air in line 307 flows via line 311 to provide feed gas to a two-bed PSA system and a second portion flows via line 313 to provide compensating gas to the bladder bag as described below.

Pressure swing adsorption system 315 comprises two adsorber vessels 317 and 319 containing an oxygen-selective adsorbent such as a carbon molecular sieve material. The PSA system includes flow control valve 321 at the feed ends of the vessels, flow control valve 323 at the product ends of the vessels, and flow control valve 325 between the product ends of the vessels. These flow control valves are operated cyclically to direct gas flow to effect the cycle steps of the PSA process as described below. These valves may be any type of rotary valve, solenoid-operated valve, or any pneumatic activated valve as known in the art. In this embodiment, the valves may be air-operated spool-and-sleeve valves with solenoid-operated pilot air flow control. Pilot air to these valves is provided via lines 327, 329, and 331.

The pilot air flows to solenoids in flow control valves 321, 323, and 325 that are controlled by PSA logic controller 333 via signal lines 335, 337, and 339, respectively. PSA logic controller 333 receives control signals from logic controller 343 via signal line 341 and controls the steps of the PSA cycle via signal lines 335, 337, and 339 when the PSA system is operating. Logic controller 343 starts and stops operation of the PSA system based on gas flow to the end user, gas pressure in the bladder tank, and gas pressure in the compensating air line as described below. Alternatively, logic controllers 333 and 343 may be combined in a single logic controller.

In this embodiment, the two adsorber vessels 317 and 319 are in flow communication at the feed ends with flow control valve 321 via lines 345 and 347, respectively. Pressurized feed air is provided to control valve 321 via line 311. PSA waste gas from flow control valve 321 flows via lines 349, 351, and 352 to silencer 353, and the waste gas is vented to the atmosphere via line 355. The product ends of adsorber vessels 317 and 319 are in flow communication with control valve 323 via lines 357 and 359, respectively. The product ends of the adsorber vessels are in flow communication via line 361, orifice 363, and control valve 325. Control valve 323 is in flow communication via line 365 with orifice 367 and check valve 369, and product nitrogen is provided via product fluid supply line 371.

The PSA system may operate according to the following exemplary cycle steps as controlled by logic controller 333 and control valves 321, 323, and 325:
(1) Pressurized feed air flows via valve 321 and line 345 into the feed end of adsorber vessel 317, the vessel is pressurized by the feed gas to operating pressure, oxygen is selectively adsorbed therein, and product nitrogen is withdrawn via line 357 and valve 323. During this pressurization/make product step of adsorber vessel 317, adsorber vessel 319 operates in a regeneration or blowdown step wherein previously-adsorbed oxygen is desorbed and together with void space gas flows via line 347, valve 321, line 349, line 351, line 352, and silencer 353, and the waste gas is vented to the atmosphere via line 355.
(2) The product end of adsorber vessel 317 is placed in flow communication with the product end of adsorber vessel 319, which has just completed its blowdown or regeneration step, and repressurization gas flows from adsorber vessel 317 to adsorber vessel 319, thereby pressurizing in the vessel to an intermediate level. During this step, the system generates no nitrogen product gas.
(3) Adsorber vessel 317 operates in a blowdown or regeneration step wherein previously-adsorbed oxygen is desorbed and together with void space gas flows via line 345, valve 321, line 349, line 351, line 352, and silencer 353, and the waste gas is vented to the atmosphere via line 355. During this period, feed air flows via valve 321 and line 347 into the feed end of adsorber vessel 319, oxygen is selectively adsorbed therein, and product nitrogen is withdrawn via line 359 and valve 323.
(4) The product end of adsorber vessel 317 is placed in flow communication with the product end of adsorber vessel 319, which has just completed its pressurization/make product step, and repressurization gas flows from adsorber vessel 319 to adsorber vessel 317, thereby increasing the pressure in the vessel to an intermediate level. During this step, the system generates no nitrogen product gas.

Steps (1) through (4) are repeated in a cyclic manner. A short non-flow period may be inserted between each step to allow time for the changing of valves 321, 323, and 325 to the next position. In one exemplary embodiment, the duration of the steps may be as follows: (1) pressurization/make product step, 55.5 sec; (2) depressurization by vessel-to-vessel gas transfer, 4.5 sec; (3) blowdown or regeneration short non-flow period, 55.5 sec; (4) pressurization by vessel-to-vessel gas transfer, 4.5 sec; and the short non-flow periods between steps may be about 0.5 sec each. The total duration of one cycle in this example is 122 sec.

Other numbers of adsorber vessels and other PSA cycles may be used if desired. For example, a single-vessel system could be used, but a larger variable-volume gas storage system would be required because no product gas would be generated during the blowdown/regeneration step. Alternatively, more than two adsorber vessels could be used, which would enable uninterrupted product delivery, but the piping and valving required would be more complex.

The PSA system described above may be integrated with the variable-volume gas storage system and the compensating gas system to provide the required product gas flow to the end user. Referring again to FIG. 3, a major portion of the pressurized feed air in line 313 flows via line 371 to valve 373 and a minor portion provides pilot air via line 375 to operate valve 373. Valve 373 operates in either of two modes according to signals from logic controller 343 via signal line 377: a first mode in which air is provided for compensating gas via line 379 and a second mode in which air flow from line 371 is shut off while residual compensating gas in the compensating gas circuit bleeds back through valve 373, orifice 381, line 383, vent lines 351 and 352, and silencer 353.

When valve 373 operates in the first mode, compensating air flows via line 379, orifice 385, and line 387 to second variable volume 23 of variable-volume gas storage system 15. This gas flow compensates for product nitrogen gas flowing out of bladder bag or flexible container 17 when product gas demand to the user via product fluid dispensing line 11 exceeds the capacity of PSA system 315. A portion of the gas exiting orifice 385 flows via line 389 to orifice 391, and is vented therefrom via lines 392 and 352, silencer 353, and line 355. The flow cross-sectional areas of the orifices are selected so that (1) the molar flow rate of compensating gas to second variable volume 23 is sufficient to compensate for the molar flow rate of product gas exiting bladder bag or first variable volume 21 via line 13 and (2) the pressure in line 387 and second variable volume 23 is essentially equal to the pressure in bladder bag or first variable volume 21.

When valve 373 operates in the second mode, air flow from line 371 is shut off and residual compensating gas in the compensating gas circuit bleeds back through valve 373, orifice 381, line 383, vent lines 351 and 352, and silencer 353. In addition, compensating gas bleeds back through line 389, orifice 391, and line 392 to line 352, silencer 353, and vent line 355. The venting gas compensates for product gas entering bladder bag or first variable volume 21 via line 13. When bladder bag or first variable volume 21 is full, all compensating gas has vented and the pressure in the compensating gas lines is approximately atmospheric.

Flow sensing switch 393 senses flow and sends a signal via signal line 394 to logic controller 343 when the flow rate in product fluid dispensing line 11 exceeds a predetermined flow rate. Flow sensing switch 393 is normally open below the predetermined flow rate and is closed at or above this flow rate.

Pressure sensing switch 395 senses the pressure in compensating gas line 387 and sends a signal via signal line 396 to logic controller 343 when the pressure in line 387 exceeds a first predetermined pressure. Pressure sensing switch 395 is normally open below the first predetermined pressure and is closed at or above this pressure.

Pressure sensing switch 397 senses the pressure in line 13 (essentially equivalent to the pressure in bladder bag or first variable volume 17) and sends a signal via signal line 398 to logic controller 343 when the pressure in line 13 exceeds a second predetermined pressure. Pressure sensing switch 397 is normally closed below the second predetermined pressure and is open at or above this pressure.

A typical operating sequence can be described to illustrate an embodiment of the invention. The sequence starts with a first mode in which the system of FIG. 3 is on standby, there is no flow demand by the end user via product fluid dispensing line 11, bladder bag or first variable volume 21 is full at the normal pressure required by the end user, and PSA system 315 is inactive. In this first mode, flow switch 393 is open, pressure sensing switch 395 is open, and pressure sensing switch 397 is closed. Logic controller 343 maintains valve 373 in a first position wherein compensating gas flow via line 371 is shut off and the compensating gas vent line 383 is in flow communication with the atmosphere via line 352, silencer 353, and vent line 355. Logic controller 343 also directs PSA logic controller 333 to inactivate valves 321, 323, and 325.

A second mode of operation begins when the end user demands product via product fluid dispensing line 11. Gas flow to the end user is immediately provided from bladder bag or first variable volume 21 via line 13, flow sensing switch 393 quickly closes, and the signal from the switch passes via signal line 394 to logic controller 343. The logic controller sends a signal via signal line 377 that activates valve 373 to send compensating gas from line 371 via line 379, orifice 385, and line 387 into second variable volume 23, thereby compensating for the product gas withdrawn from bladder bag or first variable volume 21. Some compensating gas flows to vent via orifice 391 as earlier described in order to maintain the required pressure in second variable volume 23 essentially equal to the product gas pressure in bladder bag or first variable volume 21.

A third mode of operation begins shortly thereafter in which pressure sensing switch 395 closes, and the signal from the switch passes via signal line 396 to logic controller 343. The logic controller sends a signal via signal line 341 to PSA logic controller 333, which activates the operation of PSA system 315. Product nitrogen from the PSA system begins to flow via line 365, flow control orifice 367, check valve 369, and line 371. When the end user product demand is less than the design output of the PSA system, a portion of the product gas from line 371 flows to the end user via line 11, and the remaining portion flows via line 13 to refill bladder bag or first variable volume 21. This continues until the bladder bag is full. When the end user product demand is greater than the design output of the PSA system, all product gas from line 371 flows to the end user via line 11 and the remaining product gas is provided via line 13 from bladder bag or first variable volume 21. This may continue until the bladder bag is empty, but the integrated system typically is designed so that the production capacity of PSA system 315 and the volume of bladder bag or first variable volume 21 are sufficient to satisfy the maximum end user product demand.

A fourth mode of operation begins when the end user product demand terminates. Flow switch 393 opens and the signal from the switch passes via signal line 394 to logic controller 343. The logic controller sends a signal via signal line 377 that deactivates valve 373, which shuts off compensating gas from line 371. The PSA system remains activated for a predetermined time period, and if necessary operates to fill bladder bag or first variable volume 21 during an initial portion of this time period. For the remaining portion of this time period, PSA system remains activated such that valves 321, 323, and 325 continue to operate even though there is no flow through line 365. At the end of this predetermined time period, which for example may be about 5 minutes, the system reverts to the first mode as described above and valves 321, 323, and 325 cease operation.

Over any operating period in which product gas is flowing into bladder bag or first variable volume 21, the average absolute value of the difference between the molar flow rate of the compensating gas through orifice 385 and the molar flow rate of the compensating gas through orifice 391 is essentially equal to the average absolute value of the difference between the molar flow rate of the product gas in product fluid supply line 371 and the molar flow rate of the product gas in product gas dispensing line 11. Likewise, over any operating period in which product gas is flowing out of bladder bag or first variable volume 21, the average absolute value of the difference between the molar flow rate of the compensating gas through orifice 385 and the molar flow rate of the compensating gas through orifice 391 is essentially equal to the average absolute value of the difference between the molar flow rate of the product gas in product fluid supply line 371 and the molar flow rate of the product gas in product gas dispensing line 11.

While the fluid generation, storage, and dispensing system is illustrated above for providing a nitrogen gas product, the system can be used to provide any gas, supercritical fluid, or liquid that is compatible with the materials of the PSA system, bladder bag, piping, and instrumentation components.

### EXAMPLE

The system of FIG. 3 was operated to supply nitrogen gas product to an automotive tire service system for bead seating, tire mounting, and tire inflation steps. Nitrogen at a purity of 99.5 vol % was supplied via product fluid dispensing line 11 at a delivery pressure of about 140 psig and ambient temperature. Flow rates were mostly between 0 and 8 SCFM and occasionally reached a peak flow rate of 25 SCFM during the bead seating step. Gas product demand varied randomly and depended on the activity of the tire mounting system operators.

PSA system 315 as described above utilized adsorber vessels having an inside diameter of 5.9 in. and a length of 39 in., and each vessel contains 26.5 lb of carbon molecular sieve. The PSA system operates according to the cycle described above with a cycle duration of 122 sec and is designed to provide the product purity of at least 99 vol % at production rates up to 4 SCFM. Product purity decreases above product flow of 4 SCFM, and drops to 96 vol % at a production rate of 7 SCFM.

Supply air is provided by the end user facility via line 301 at 150 psig. The PSA product pressures in line 371, the product gas pressure in bladder bag or first variable volume 21, and the compensating gas pressure in second variable volume 23 average 140 psig. Bladder bag or first variable volume 21 is made of butyl rubber and has a volume of 4.7 cu ft when full and in contact with the interior surface of pressure vessel 19.

Flow sensing switch 393 is normally open below 1.2 SCFM and is closed at or above this flow rate. Pressure sensing switch 395 is normally open below 80 psig and is closed at or above this pressure. Pressure sensing switch 397 is normally closed below 95 psig and is open at or above this pressure. The orifice diameters are as follows: 363, 0.100 in.; 367, 0.100 in.; 381, 0.021 in.; 385, 0.050 in.; and 391, 0.018 in.

The embodiments of the storage and dispensing system described above may be used to supply pressurized gas at variable and intermittent flow for any type of application. Some representative applications include but are not limited to inerting tanks and containers, product packaging, pipeline purging, and operating equipment in automotive tire shops. In this latter application, for example, the gas may be used for tire mounting and dismounting machines, tire inflation, and impact wrenches and other gas-operated tools.

1. A fluid storage and dispensing system comprising
(a) a pressure vessel having an inner surface, an interior, an exterior, and a rigid wall between the interior and exterior;
(b) a moveable partition member disposed in the interior of the pressure vessel, wherein the partition member divides the interior into a first variable volume and a second variable volume, and wherein the first variable volume is not in flow communication with the second variable volume;
(c) a first passage passing through the rigid wall of the pressure vessel and into the first variable volume wherein the first passage is adapted to introduce a product fluid into the first variable volume and withdraw the product fluid from the second variable volume;
(d) a second passage passing through the rigid wall of the pressure vessel and into the second variable volume wherein the second passage is adapted to introduce a compensating gas into the second variable volume and withdraw the compensating gas from the first second volume; and
(e) a compensating gas supply system that includes
(1) a compensating gas line placing the second passage in flow communication with a source of compensating gas;
(2) a first orifice installed in the compensating gas line and having an upstream side and a downstream side;
(3) a compensating gas vent line in flow communication with the compensating gas line at a location between the second passage and the downstream side of the first orifice, wherein the compensating gas vent line is adapted to discharge compensating gas from the compensating gas line to the atmosphere; and
(4) a second orifice installed in the compensating gas vent line, wherein the cross-sectional flow area of the second orifice is smaller than the cross-sectional flow area of the first orifice.

2. The system of claim 1 wherein the first and second variable volumes within the interior of the pressure vessel are defined by a moveable partition member selected from the group consisting of a bladder bag, a bellows, a flexible diaphragm, and a piston forming a slideable seal with the inner surface of the pressure vessel.

3. A fluid storage and dispensing system comprising
(a) a pressure vessel having an inner surface, an interior, an exterior, and a rigid wall between the interior and exterior;
(b) a flexible fluid container disposed in the interior of the pressure vessel, wherein the flexible fluid container has an interior, an outer surface, and an opening connecting the interior of the container with a first passage through the rigid wall of the pressure vessel;
(c) a first variable volume defined by the interior of the flexible fluid container, wherein the first passage is in flow communication with a product fluid supply line and a product fluid dispensing line and is adapted to introduce a product fluid into the first variable volume and withdraw the product fluid from the first variable volume;
(d) a second variable volume defined by the inner surface of the pressure vessel and the outer surface of the flexible fluid container, wherein the second variable volume is in flow communication with a second passage adapted to introduce a compensating gas into the second variable volume and to withdraw the compensating gas from the second variable volume; and
(e) a compensating gas supply system that includes
(1) a compensating gas line placing the second passage in flow communication with a source of compensating gas;
(2) a first orifice installed in the compensating gas line and having an upstream side and a downstream side;
(3) a compensating gas vent line in flow communication with the compensating gas line at a location between the second passage and the downstream side of the first orifice, wherein the compensating gas vent line is adapted to discharge compensating gas from the compensating gas line to the atmosphere; and
(4) a second orifice installed in the compensating gas vent line, wherein the cross-sectional flow area of the second orifice is smaller than the cross-sectional flow area of the first orifice.

4. The system of claim 3 wherein the product fluid is nitrogen gas.

5. The system of claim 3 wherein the compensating gas is air.

6. The system of claim 3 wherein the flexible fluid container is a bladder bag made of polymeric material.

7. The system of claim 6 wherein when the outer surface of the bladder bag is in contact with the inner surface of the rigid pressure vessel such that the second variable volume is essentially zero and the polymeric material of the bladder bag is in a non-stretched condition.

8. The system of claim 4 comprising a pressure swing adsorption system adapted to recover the nitrogen gas from a pressurized air feed stream.

9. The system of claim 4 comprising a membrane separation system adapted to recover the nitrogen gas from a pressurized air feed stream.

10. The system of claim 3 comprising a three-way valve having a first port, a second port, and a third port, wherein the first port is connected to the source of compensating gas, the second port is connected to the compensating gas line upstream of the first orifice, the third port is connected to an additional vent line, and a third orifice is installed in the additional vent line, and wherein the three-way valve is adapted to operate in a first position that places the source of compensating gas in flow communication with the compensating gas line upstream of the first orifice while closing off the additional vent line and to operate in a second position that places the third vent line in flow communication with the compensating gas line upstream of the first orifice while closing off the source of compensating gas.

11. A method of storing and dispensing a fluid comprising
(a) providing a fluid storage and dispensing system that comprises
(1) a pressure vessel having an inner surface, an interior, an exterior, and a rigid wall between the interior and exterior;
(2) a flexible fluid container disposed in the interior of the pressure vessel, wherein the flexible fluid container has an interior, an outer surface, and an opening connecting the interior of the container with a first passage through the rigid wall of the pressure vessel;
(3) a first variable volume defined by the interior of the flexible fluid container, wherein the first passage is in flow communication with a product fluid supply line and a product fluid dispensing line and is adapted to introduce a product fluid into the first variable volume and withdraw the product fluid from the first variable volume;
(4) a second variable volume defined by the inner surface of the pressure vessel and the outer surface of the flexible fluid container, wherein the second variable volume is in flow communication with a second passage adapted to introduce a compensating gas into the second variable volume and to withdraw the compensating gas from the second variable volume; and
(5) a compensating gas supply system that includes
(i) a compensating gas line placing the second passage in flow communication with a source of compensating gas;
(ii) a first orifice installed in the compensating gas line and having an upstream side and a downstream side;
(iii) a compensating gas vent line in flow communication with the compensating gas line at a location between the second passage and the downstream side of the first orifice, wherein the compensating gas vent line is adapted to discharge compensating gas from the compensating gas line to the atmosphere; and
(iv) a second orifice installed in the compensating gas vent line, wherein the cross-sectional flow area of the second orifice is smaller than the cross-sectional flow area of the first orifice;
(b) during a first time period, withdrawing product fluid from the first variable volume, combining it with product fluid from the product fluid supply line to provide a combined product fluid, introducing the combined product fluid into the product fluid dispensing line, and introducing compensating gas into the second variable volume via the first orifice and the compensating gas line; and
(c) during a second time period, introducing a first portion of product fluid from the product fluid supply line into the product fluid dispensing line, introducing a second portion of product fluid from the product fluid supply line into the first variable volume, and withdrawing compensating gas from the second variable volume via the second orifice and the compensating gas vent line.

12. The method of claim 11 wherein during a third time period all product fluid from the product fluid supply line is introduced into the product fluid dispensing line and no compensating gas is introduced into or withdrawn from the second variable volume.

13. The method of claim 11 wherein the product fluid is nitrogen gas and the compensating gas is air.

14. A gas generation, storage, and dispensing system comprising
(a) a pressure vessel having an inner surface, an interior, an exterior, and a rigid wall between the interior and exterior;
(b) a flexible gas container disposed in the interior of the pressure vessel, wherein the flexible gas container has an interior, an outer surface, and an opening connecting the interior of the container with a first passage through the rigid wall of the pressure vessel;
(c) a first variable volume defined by the interior of the flexible gas container, wherein the first passage is in direct flow communication with a product gas supply line and a product gas dispensing line and is adapted to introduce a product gas into the first variable volume and withdraw the product gas from the first variable volume;
(d) a second variable volume defined by the inner surface of the pressure vessel and the outer surface of the flexible fluid container, wherein the second variable volume is in flow communication with a second passage adapted to introduce a compensating gas into the second variable volume and to withdraw the compensating gas from the second variable; and
(e) a pressure swing adsorption system comprising at least one vessel containing adsorbent material adapted to preferentially adsorb a more strongly adsorbable component from a gas mixture comprising the more strongly adsorbable component and a less strongly adsorbable component to provide an effluent gas enriched in the less strongly adsorbable component, wherein the pressure swing adsorption system includes outlet piping adapted to provide the effluent gas directly to the first variable volume via the product gas supply line and the first passage.

15. The system of claim 14 wherein the flexible fluid container is a bladder bag made of polymeric material.

16. The system of claim 15 wherein when the outer surface of the bladder bag is in contact with the inner surface of the rigid pressure vessel such that the second variable volume is essentially zero, the polymeric material of the bladder bag is in a non-stretched condition.

17. A method for generating, storing, and dispensing a gas comprising
(a) providing a gas storage and dispensing system that comprises
(1) a pressure vessel having an inner surface, an interior, an exterior, and a rigid wall between the interior and exterior;
(2) a flexible gas container disposed in the interior of the pressure vessel, wherein the flexible gas container has an interior, an outer surface, and an opening connecting the interior of the container with a first passage through the rigid wall of the pressure vessel;
(3) a first variable volume defined by the interior of the flexible gas container, wherein the first passage is in direct flow communication with a product gas supply line and a product gas dispensing line and is adapted to introduce a product gas into the first variable volume and withdraw the product gas from the first variable volume;
(4) a second variable volume defined by the inner surface of the pressure vessel and the outer surface of the flexible gas container, wherein the second variable volume is in flow communication with a second passage adapted to introduce a compensating gas into the second variable volume via a compensating gas line and to withdraw the compensating gas from the second variable volume via the compensating gas line; and
(b) introducing a feed gas mixture comprising a more strongly adsorbable component and a less strongly adsorbable component into an adsorber vessel containing adsorbent material, preferentially adsorbing a portion of the more strongly adsorbable component on the adsorbent material, withdrawing from the adsorber vessel an effluent gas enriched in the less strongly adsorbable component to provide the product gas, and introducing the product gas directly into the product gas supply line.

18. The method of claim 17 wherein
(c) during a first time period, withdrawing product gas from the first variable volume, combining it with product gas from the product gas supply line to provide a combined product gas, introducing the combined product gas into the product gas dispensing line, and introducing compensating gas into the second variable volume via the first orifice and the compensating gas line; and
(d) during a second time period, introducing a first portion of the product gas from the product gas supply line into the product gas dispensing line, introducing a second portion of product gas from the product gas supply line into the first variable volume, and withdrawing compensating gas from the second variable volume via the second orifice and the compensating gas vent line.

19. The method of claim 18 wherein during the first time period or the second time period the average absolute value of the difference between the molar flow rate of the compensating gas through the first orifice and the molar flow rate of the compensating gas through the second orifice is essentially equal to the average absolute value of the difference between the molar flow rate the product gas in the product fluid supply line and the molar flow rate of the product gas in the product gas dispensing line.

20. The method of claim 17 wherein the feed gas mixture is air and the less strongly adsorbed component is nitrogen.

21. The method of claim 20 wherein the compensating gas is air.

22. The method of claim 21 wherein the feed gas mixture and the compensating gas are provided by a common pressurized air supply source.

23. The method of claim 17 which comprises sensing the product gas pressure in the first variable volume, sensing the compensating gas pressure in the second variable volume, and sensing the product gas flow rate in the product gas dispensing line.

24. The method of claim 23 wherein when the compensating gas pressure in the second variable volume is greater than a first designated pressure, when the product gas pressure in the first variable volume is less than a second designated pressure, and when the product gas flow rate in the product gas dispensing line is greater than a designated flow rate, (i) introducing a flow of the feed gas mixture into the adsorber vessel, withdrawing a flow of product gas from the adsorber vessel, and introducing the product gas directly into the product gas supply line and (ii) introducing a flow of compensating gas into the second variable volume or withdrawing a flow of compensating gas from the second variable volume.

25. The method of claim 24 wherein when the compensating gas pressure in the second variable volume is less than a first designated pressure, when the product gas pressure in the first variable volume is less than a second designated pressure, and when the product gas flow rate in the product gas dispensing line is less than a designated flow rate, (i) terminating the flow of the feed gas mixture into the adsorber vessel, terminating the flow of product gas withdrawn from the adsorber vessel, and (ii) terminating the flow of compensating gas into the second variable volume or terminating the flow of compensating gas withdrawn from the second variable volume.
